(19) United States
(12) Patent Application Publication
(10) Pub. No.: US 2005/0171912 A1
(43) Pub. Date: Aug. 4, 2005

(54) Multi-part to multi-box consolidation graphic user interface

(76) Inventor: James Fenelon, Austin, TX (US)

Correspondence Address: PERMAN & GREEN, 425 POST ROAD, FAIRFIELD, CT, 06824, US

(21) Appl. No.: 10/768,812

(22) Filed: Jan. 30, 2004

(51) Int. Cl. G06F 17/60

(52) U.S. Cl. 705/50

(57) ABSTRACT

A method and system for managing a return of parts. The method includes identifying a set of inventory associated with a return authorization, identifying which parts of the set of inventory are to be returned, determining a type of browser being used by a user returning parts, associating each part being returned with a shipping container in which the part being returned will be shipped, wherein each part number is associated with a shipping container, determining a total weight for each shipping container, identifying a shipping date and a shipping carrier, identifying whether a shipping carrier pick-up needs to be scheduled, and a date and time for the pickup, printing a shipping label for each shipping container, each label being automatically generated by the system and including a number of the shipping container and a list of parts to be shipped in the shipping container.

### BACKGROUND OF THE INVENTION

1. Field of the Invention

The present invention generally relates to management of return inventory and in particular to a web enabled multi-return merchandise authorization process.

2. Brief Description of Related Developments

Online merchandise return tools generally facilitate the return of one part from a list of parts contained in a return merchandise authorization (“RMA”) These online merchandise return tools generally require a customer to loop through the process several times if there were multiple parts to return.

It would be beneficial to have an online merchandise return system that allows a customer to return as many parts of their RMA as desired and to configure the shipment in any suitable manner.

### SUMMARY OF THE INVENTION

The present invention is directed to a method of managing a return of parts. In one embodiment, the method comprises identifying a set of inventory associated with a return authorization, identifying which parts of the set of inventory are to be returned, determining a type of browser being used by a user returning parts, associating each part being returned with a shipping container in which the part being returned will be shipped, wherein each part number is associated with a shipping container, determining a total weight for each shipping container, identifying a shipping date and a shipping carrier, identifying whether a shipping carrier pick-up needs to be scheduled, and a date and time for the pickup, printing a shipping label for each shipping container, each label being automatically generated by the system and including a number of the shipping container and a list of parts to be shipped in the shipping container.

The present invention is directed to a method of merchandise return. In one embodiment the method comprises accessing a return merchandise application using a unique return merchandise authorization number, selecting individual parts to be returned from a parts list that is automatically displayed and associated with the return merchandise authorization number, associating each selected part to be returned with a shipping container in which each selected part is to be returned, selecting a shipping carrier for shipping each shipping container and scheduling a time and a date for the shipment, and automatically generating a shipping label for each respective shipping container.

In another aspect the present invention is directed to a computer program product. In one embodiment the computer program product comprises a computer useable medium having computer readable code means embodied therein for causing a computer to facilitate a return of parts. The computer readable code means in the computer program product comprises computer readable program code means for causing a computer to access a return merchandise application using a unique return merchandise authorization number, computer readable program code means for causing a computer to select individual parts to be returned from a parts list that is automatically displayed and associated with the return merchandise authorization number, computer readable program code means for causing a computer to select a shipping carrier for shipping each shipping container and scheduling a time and a date for the shipment, and computer readable program code means for causing a computer to automatically generate a shipping label for each respective shipping container.

In a further embodiment, the present invention is directed to a graphical user interface adapted for generating a visual display for facilitating a return of merchandise from a customer to a customer service center. In one embodiment the graphical user interface comprises a display screen, and an image generator for generating on the display screen a menu selection screen for a return merchandise authorization. The menu selection screen comprises a user actuatable control to associate a shipping container with a part to be returned as displayed on the display screen, a user actuatable control to select a shipping container and verify a designated contents of the shipping container as displayed on the display screen, a user actuatable control to designate a shipping carrier for picking up each shipping container, and a user actuatable control for scheduling a time and date for the pick up and automatically notifying the shipping carrier of the scheduled pick up.

### BRIEF DESCRIPTION OF THE DRAWINGS

The foregoing aspects and other features of the present invention are explained in the following description, taken in connection with the accompanying drawings, wherein:

FIG. 1 is a schematic diagram of one embodiment of a system incorporating features of the present invention.

FIG. 2 is a screen of a graphical user interface showing a login to a return merchandise authorization processing application.

FIG. 3 is one embodiment of a screen of a graphical user interface illustrating return part information for a return merchandise authorization process incorporating features of the present invention.

FIG. 4 is one embodiment of a screen of a graphical user interface illustrating box associations for each part to be returned.

FIG. 5 is one embodiment of a screen of a graphical user interface illustrating box configurations for each box containing parts to be returned.

FIG. 6 is one embodiment of a screen of a graphical user interface illustrating shipment methods and information for the shipment.

FIG. 7 is one embodiment of a screen of a graphical user interface illustrating label options for each box in the shipment.

FIG. 8 is one embodiment of a screen of a graphical user interface illustrating an RMA shipment receipt.

FIG. 9 is one embodiment of a screen of a graphical user interface illustrating return part information, box configuration and shipping details, for a return merchandise authorization application incorporating features of the present invention.

FIG. 10 is one embodiment of a screen of a graphical user interface for generating shipping labels and receipts in a return merchandise authorization system of the present invention.

FIG. 11 is a flow chart of one embodiment of a method incorporating features of the present invention.

FIG. 12 is a block diagram of an architecture that can be used to practice embodiments of the present invention.

FIG. 13 is a flowchart illustrating one embodiment of a method incorporating features of the present invention.

### DETAILED DESCRIPTION OF THE PREFERRED EMBODIMENT(s)

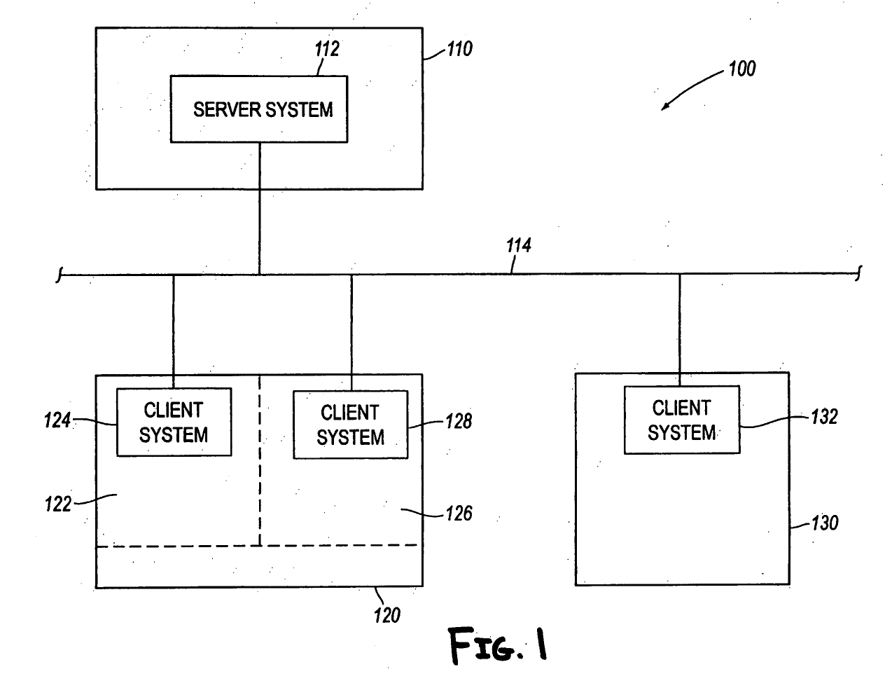

Referring to FIG. 1, a perspective view of a system 10 incorporating features of the present invention is illustrated. Although the present invention will be described with reference to the embodiments shown in the drawings, it should be understood that the present invention could be embodied in many alternate forms of embodiments. In addition, any suitable size, shape or type of elements or materials could be used.

Referring to FIG. 1, the return merchandise system of the present invention is implemented via an electronic communication network 100, such as for example the Internet (“WWW”). The network 100 can comprise a server system 112 connected or coupled to service or return center 110. Although the term “site” is associated with the service center 110, it is not meant to imply the actual location of the service center 110, as the server system 112 could be located remotely from the service center 110. For example, the service center 110 could easily be located hundreds of miles from the server 112.

The server system 112 maintains the application program that runs the return merchandise system. The server system 112 is connected by a communications network 114 to any number of client systems 124, 128 and 132. Although the term “client systems” is used herein, the term generally refers to a customer or client, and such terms can be used interchangeably with the same meaning. Each client system 124, 128 and 132 is adapted to access the return merchandise application program stored on the server system 112, to log in, and communicate with the server system 112 to arrange for merchandise or parts return. It is a feature of the present invention to allow a user to login to an online application for merchandise return and arrange for the return as many parts of their return merchandise authorization as they desire. The present invention allows a client 124, 128, 132 to return just one or any combination of the parts listed on the RMA. The server system 112 can determine how many parts to expect and have a general idea as to how many boxes the client will be using.

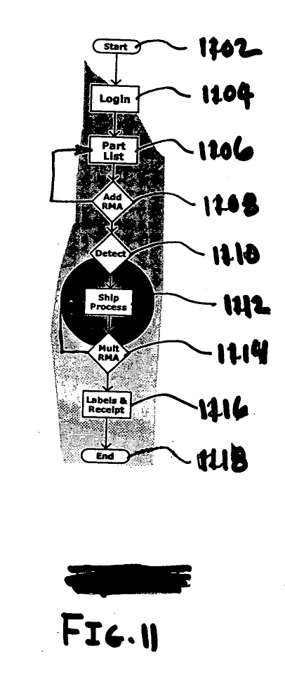

Referring to FIGS. 1 and 11, in one embodiment a client system, say for example, client system 124 desires to return merchandise to a service center 110. The client system 124 will make contact with the service center to obtain a return merchandise authorization (“RMA”). This could be done by telephone, electronically, or any suitable means, for example. Generally, by their nature, no RMA is the same. The number of parts for each RMA can vary. It is a feature of the present invention to allow a customer to handle variable RMA part lists in a flexible fashion, and configure a shipment according to their specific situation. When the client 124 contacts the service center 110 to request an RMA, the client 124 may identify the parts desired to be returned, or may refer to a purchase of a number of parts. The service center 110 can then generate an RMA for all of the parts. However, the service center 110 has no way of knowing at this point how the parts to be returned will be shipped, when they will be shipped, and indeed if all of the parts originally detailed for the RMA will be returned, or returned at the same time.

The client system 124 will be provided with a login code that is associated with the RMA, as provided by the service center 110. When the client system 124 is ready to begin the return merchandise process, the client system 124 electronically accesses the return merchandise application on the server system 112 and logs in, 1104, to the return merchandise application. Upon the client system login, the associated RMA file is retrieved and a list of parts associated with the RMA is displayed to the client 124. The login 1104 can comprise logging into a web-enabled application that displays pages of the accessed sited to the client 124. Generally, each RMA includes a varied number of parts. The return merchandise application relies on the RMA file to communicate the number of parts and the associated weight. This information is then obtained dynamically upon the client system 124 login 1104.

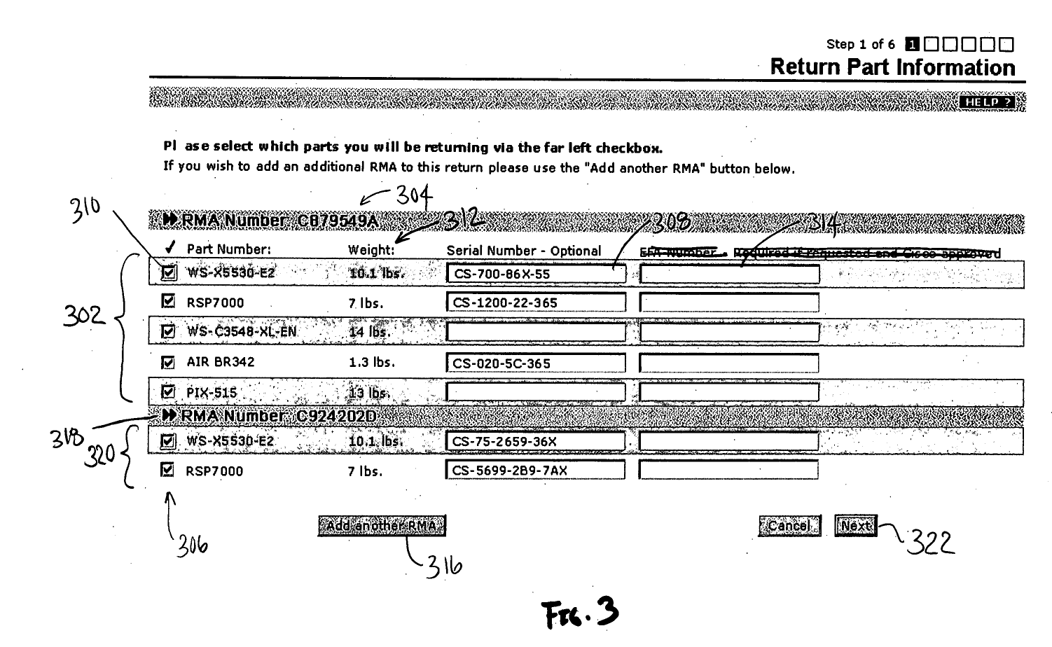

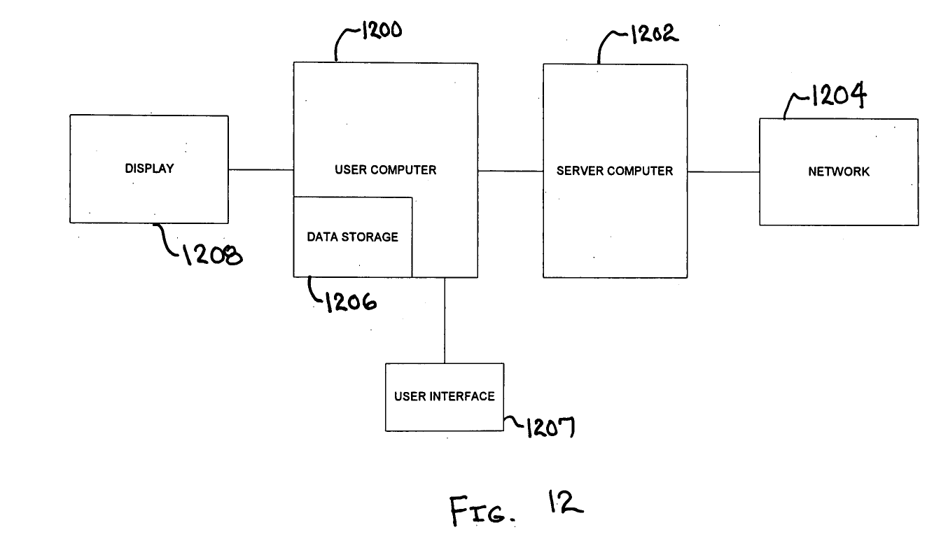

Once the return merchandise application obtains the RMA file information, the information can be displayed 1106 graphically for the client system 124. An example of such a display is illustrated in FIG. 3. As part of step 1106 of FIG. 11, the client system 124 can specifically indicate which parts are to be returned. The client system 124, also referred to as a customer, can return just one, all, or any combination of the parts listed, or associated with the RMA, as shown in FIG. 3. It is a feature of the present invention to allow customers 124 to return as many parts of their RMA as they desired. Prior online tools required a user to loop through the process several times if multiple parts were to be returned. The selection of which parts are being returned, step 1106 in FIG. 12, helps the server system 112, and the associated service center 110, determine how many parts to expect and to provide a general idea as to how many boxes the customer will be using. (If there are 50 parts to be returned, the application knows that, at the most 50 boxes, or merchandise shipping units or containers, will be used.) The customer 124 has the option to add, 1108, additional RMA numbers to the current return, in the event that more than one RMA has been obtained. It is a feature of the present invention to be able to add any number of RMAs to a single merchandise return process.

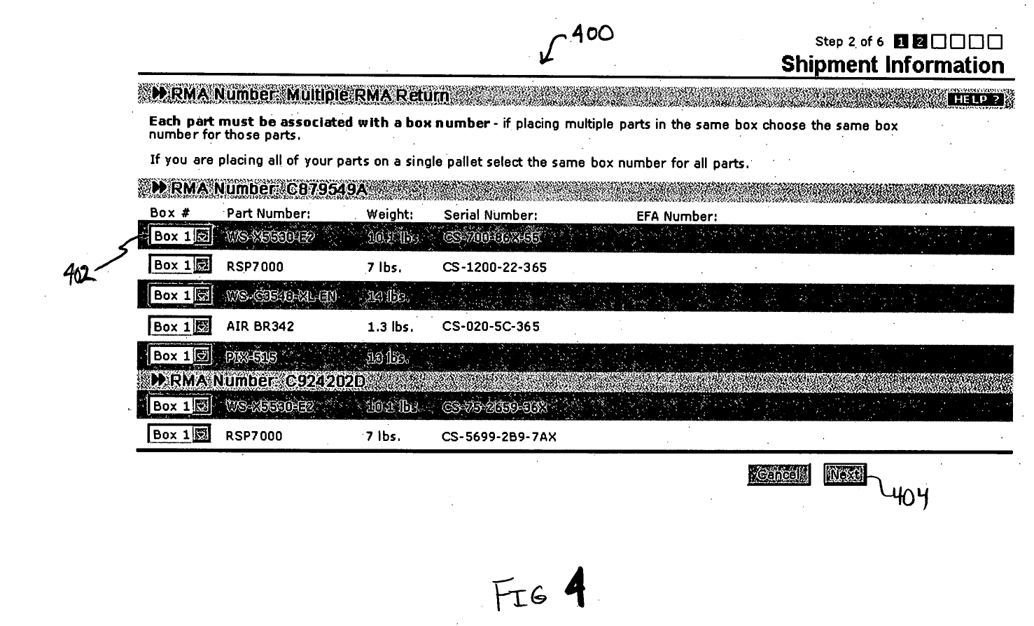

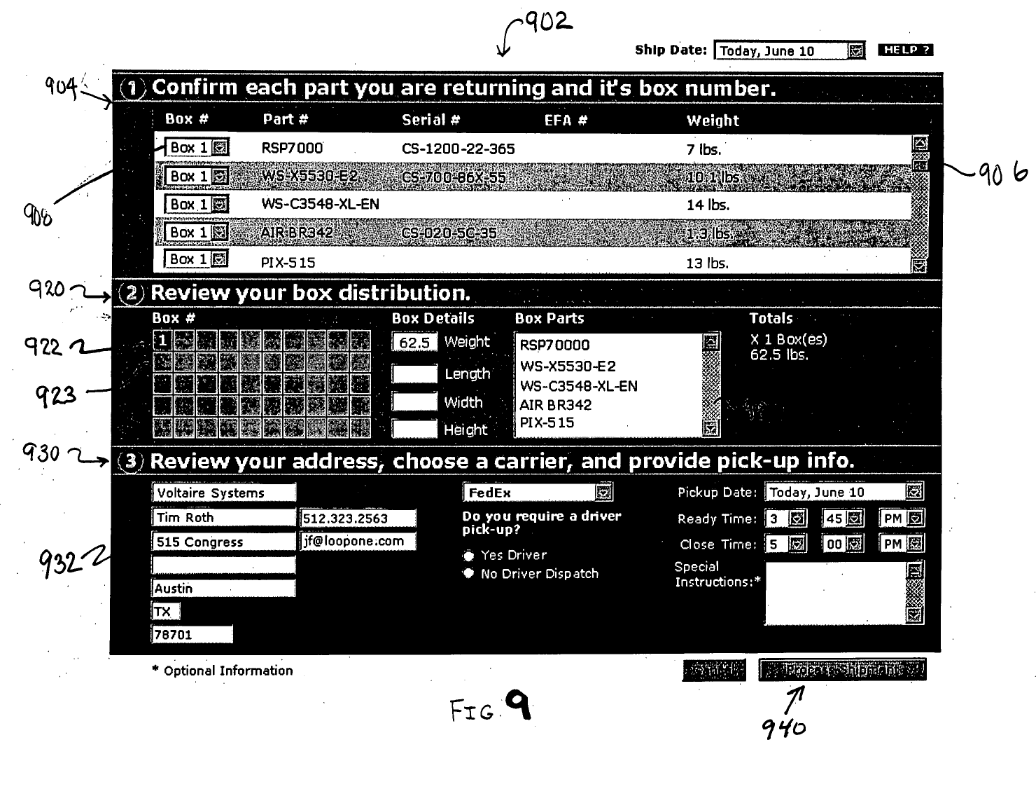

Once the parts to be returned are identified, 1206 and 1208, the server system 112 of FIG. 1 allows the client system 124 to allocate these parts to boxes or other suitable shipping containers, step 1112. The system provides the client 124 the flexibility to decide how many shipping containers to use to return the parts, as well as decide which parts will be shipped in which container. There may be logistical reasons to ship certain parts in a single container or box, or even ship each part in a separate container. In one embodiment, the server application 112 may request that certain parts be shipped together. Examples of the interfaces that can be used to allow the customer 124 to allocate parts to boxes are shown in FIGS. 4 and 9. In step 1110 of FIG. 11, the server system 112 is adapted to detect if a browser associated with the client system 124 is a non-standards compliant browser, as opposed to a dynamic, standards compliant browser system, the standard being the W3C (world wide web consortium), the standards governing body of the Internet. With a non-compliant browser, the interface 400 of FIG. 4 will be presented to the customer. For a dynamic browser, the interface 902 of FIG. 9 can be presented. In alternate embodiments, any suitable interface can be used that allows a user to make a selection of parts from a list and associate a box number or other shipping identifier with each selected part.

The number of boxes made available to the customer will not exceed the number of parts to be returned. Thus, if there are only four parts to be returned, only four box choices will be made available to the user. The client system 124 will have the option to use as many boxes as desired to return the parts.

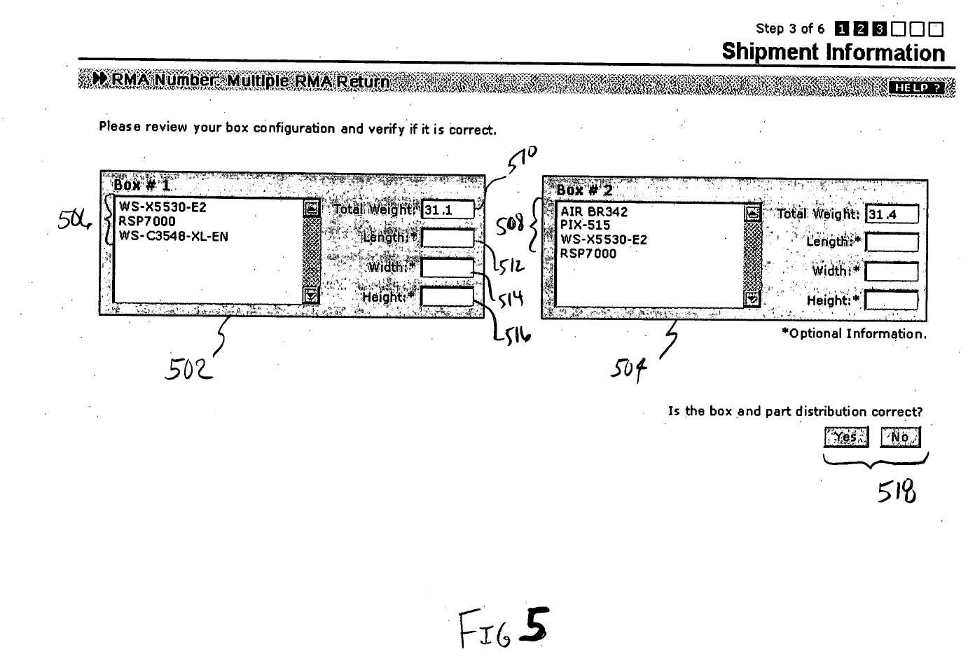

Further, as part of the shipment processing step 1212, the user will be presented with a visual breakdown of each box allocation in order to verify the shipping configurations. Examples of this can be seen with reference to FIGS. 5 and 9.

If multiple RMAs are being sent in the shipment, step 1214, the user can go through the shipment process 1212 for each RMA.

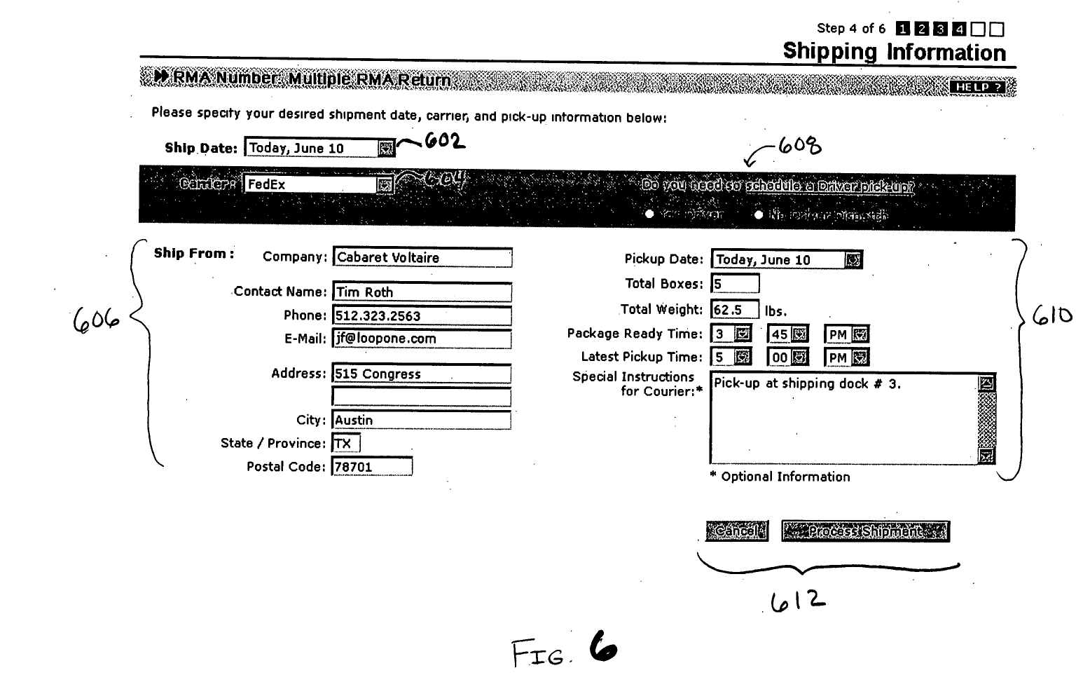

The user can then schedule the shipment of the parts by selecting a carrier and arranging a pick-up time. Examples of this are shown with reference to FIGS. 6 and 9. In this manner, the server system 112, or service center, knows that a return shipment will be initiated or carried out on a certain date. The server 112 will have the information related to the shipping containers and the contents, and will be able to decide in advance, if necessary, how to handle or direct the return. The service center 110 will receive the information after the client/customer has completed the process.

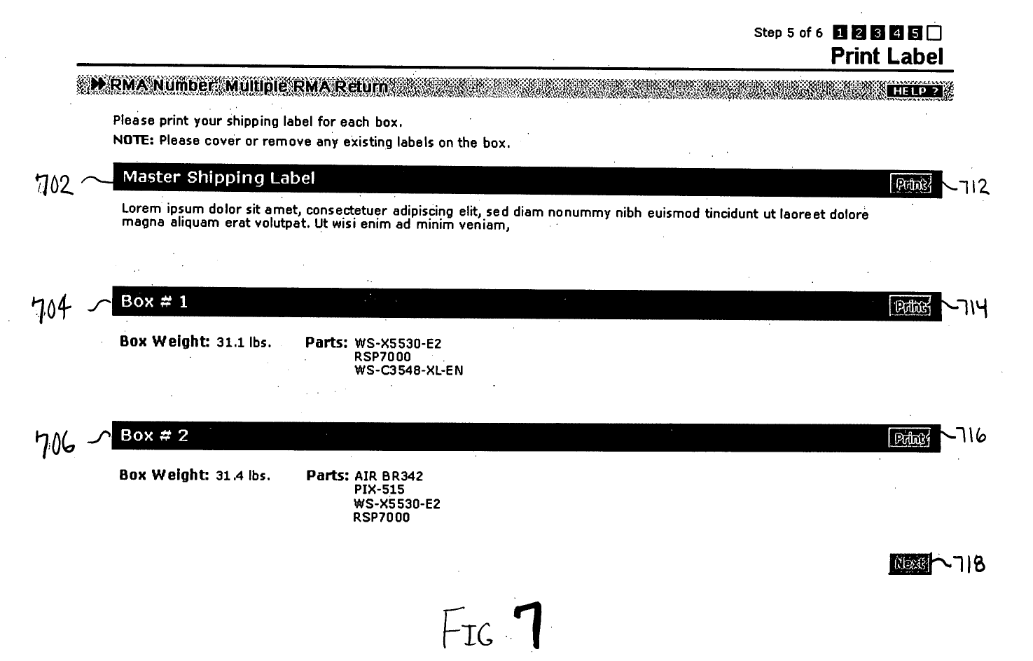

Once all the shipping information and processing are verified, the customer can then print out the shipping labels and receipt, step 1216. Each box will have a shipping label based on the information entered. Examples are illustrated with reference to FIGS. 7 and 11.

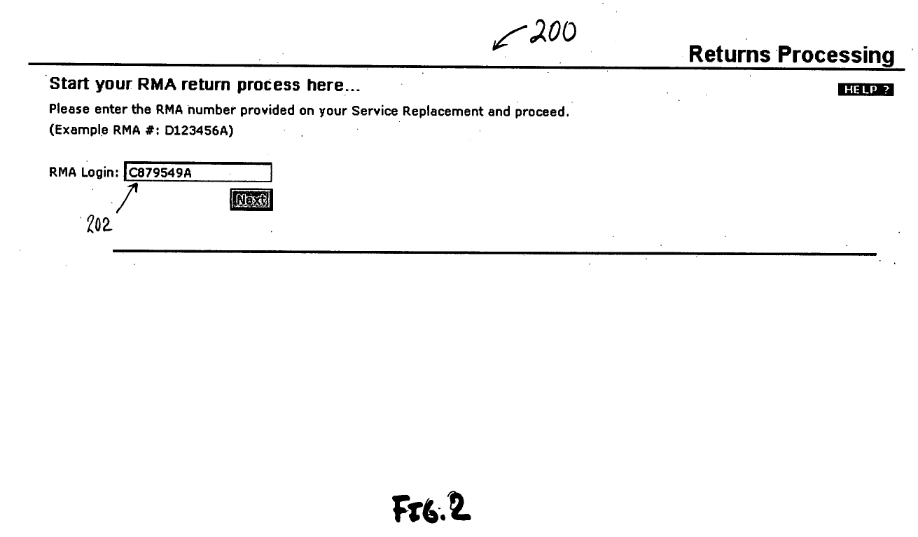

Referring to FIG. 2, the disclosed embodiments all the returns processing application to begin or be initiated, after the RMA number is obtained, by entering the RMA number provided on the service replacement authorization. The RMA number can be obtained by contacting the service center or vendor of the parts that are to be returned. This contact can be made manually, such as for example by telephone, or electronically such as for example by email. The login 202 will generally coincide with a return authorization and an inventory of parts to be returned will be associated with the RMA. The login 202 allows the user to access a database at the service center or associated with the service center. The database or such other similar storage mechanism or system maintains the relationship between the RMA number and the parts to be returned, including any data or information obtained by the service center about the user.

Referring to FIG. 3, when the RMA number login is accepted and verified, the user can be prompted to select the parts to be returned. A list of parts 302 that are associated with the RMA number 304 is displayed. The user can individually select via a selection area 306, or such other suitable mechanism, which of the parts 302 listed will be returned. The user can also include a serial number 308 for the selected part 310. If available, the weight 312 of each listed part 302 could also be provided. Other information fields 314 could also be provided if needed.

In one embodiment, if more than one set of parts is going to be returned, or another RMA number has been obtained for additional parts, any number of additional RMA numbers and lists can be added. For example, by activation of a menu option 316 to add another RMA, the user would be prompted to login the other RMA number 318, on a screen 200, such as that shown in FIG. 2. If the login is successful, the next RMA number 318 will be displayed, together with a list of parts 320 associated with the RMA 318. Any number of additional RMAs can be added to a single return.

Once the return part information shown in FIG. 3 is complete, each part number 302 and 320 that is going to be returned must be associated with a box number 402. Multiple parts can be placed in the same box or shipping container, or pallet. The user can select the box number 402 into which each part will be placed.

Once the boxes for shipping have been selected, referring to FIG. 5, the user can verify that the shipment information 502, 504 for each box is correct. As shown in FIG. 5, each box configuration block shows a list 506, 508 of the part numbers to be shipped in the box. Other information fields can be included, including for example a total weight 510 of the box, a length 512 of the box, a width 514 of the box and a height 516 of the box. The user can review the information and verify 518 that the box configurations 502, 504 are correct.

Once the box configuration is verified as being correct, the user can then input the shipment information. Referring to FIG. 6, the user can specify the shipment date 602 and select a carrier 604. The user can also provide the information 606 related to where the shipment is being shipped from. The user can specify driver need information 608 as well as pick-up information 610. The pick-up information can include for example, the pick-up date, the number of boxes, the total weight, when the packages will be ready and the latest time to pick the shipment up. The user could also include any special instructions for the courier or carrier, or any additional information. Once all the necessary shipment information is entered, the user can proceed to process 612 the shipment.

Referring to FIG. 7, the present invention automatically generates a Master Shipping Label 702, as well as a shipping label 704, 706 for each box. The labels can be printed and used as needed.

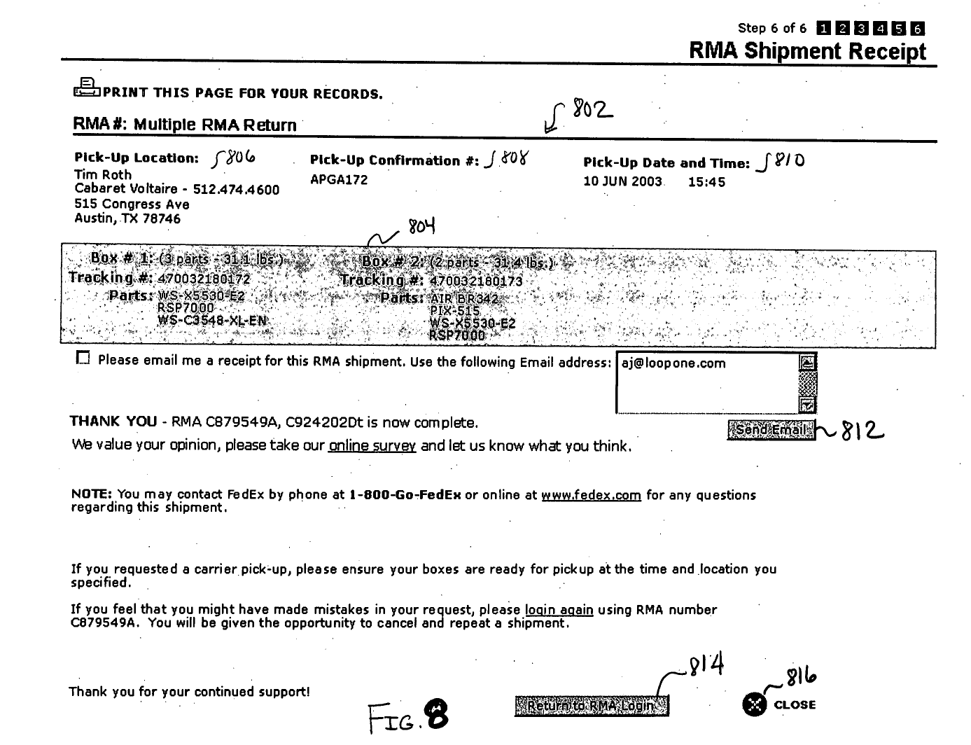

A shipment receipt 802, referring to FIG. 8, can also be made available for the user to retain, by printing or electronic storage. A description or detail 804 of each box being shipped is provided. The shipment receipt could also include information related to the pick-up location 806, the pick-up confirmation 808, and pick-up time and date 810. The user could also request 812 an email receipt for the shipment. Once the shipment receipt 802 page is returned, the user can return 814 to enter a new RMA number or close the application.

Referring to FIG. 9, if the user browser application is a dynamic one, a more concise and detailed process for inputting the information related to the shipment can be used. Once the user has logged into the return system, such as shown in FIG. 1, and the parts to be returned are selected, including the addition of more that one RMA number to the return, the application at the service center server detects whether the user's browser is a non-compliant browser or a dynamic browser. If non-compliant, the process proceeds as described with reference to FIGS. 3-8. If the user's browser is dynamic the user is presented with a dynamic or interactive information input screen 902, as shown in FIG. 9.

In FIG. 9, a first portion 904 of the page 902 allows the user to confirm which parts are being returned and the box number 908 of the box in which the part is being returned. A scroll bar 906 allows the user to scroll down the page portion 904 to review additional part numbers.

Once the user has completed confirming each part being returned and the box number of the box in which it will be shipped, the user can review the box distribution 920. A grid 922 is presented. In each subpart or square 923 of the grid 922, a box number corresponding to box numbers identified in 904, is displayed. In FIG. 9, only a box #1 is shown in the grid 922, since parts are only being shipped in box #1. Had the user specified to ship parts in other box numbers, those box numbers would appear in the grid as well.

In order to review the box distribution, the user selects or clicks on a desired box number. Once the box number is highlighted or selected, the details of each box are displayed in the fields 924, 926 and 928. The box details 924, including weight, length width and height are shown. The parts being returned are all displayed in the Box Parts field 926. The Box Parts field 926 includes a comprehensive listing of all the parts being returned. A scroll bar 927 is provided to allow the user to scroll down the list of parts. A total field 928 shows the number of boxes being used to return the parts and the total weight.

Once review of the box distribution 920 is complete, the user can review the address information, choose carrier and provide pick-up information 930. The address information 932 includes the sender's mailing information. The user can select a carrier in 934, as well as select whether a driver pick-up is required in field 936. The pick-up information, date and time, and any special instructions can be indicated in 938. Once all of the information required in section 930 is reviewed and complete, the user can process the shipment by activating the button or field 940.

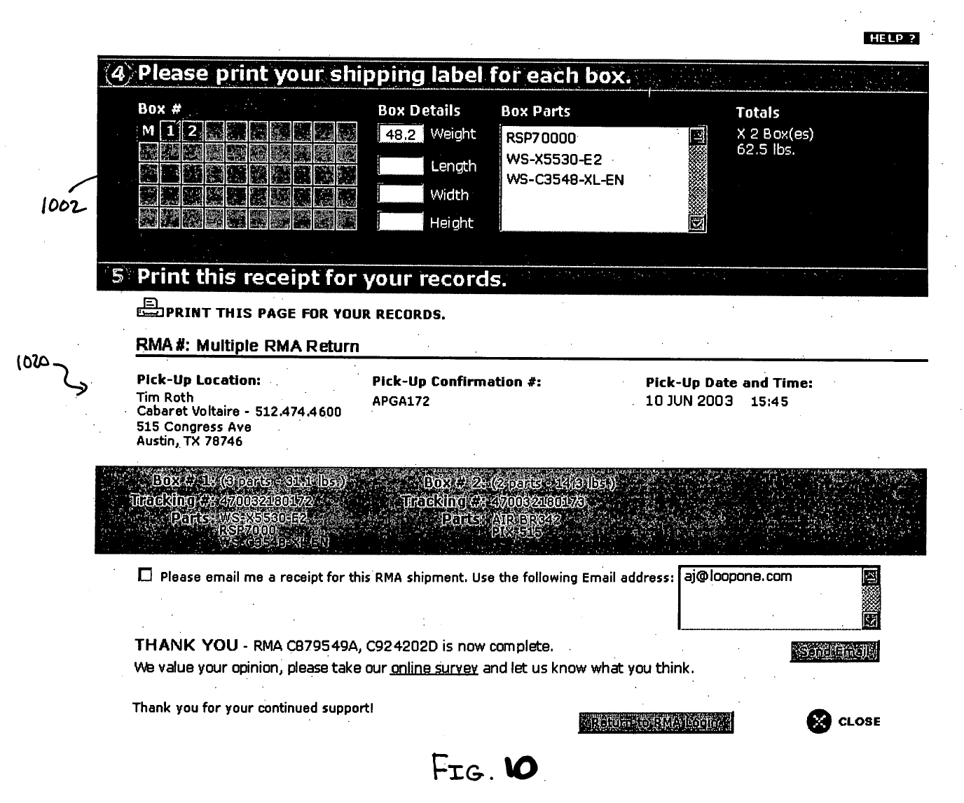

Referring to FIG. 10, the disclosed embodiments allow the user to print a shipping label for each box. By highlighting a respective area of the grid 1002 corresponding to the desired box number, a shipping label for the box is generated. For example, grid 1002 shows that two boxes are scheduled to be shipped. By selecting Box #1, 1004, the details of the Box #1 are displayed in fields 1006 and 1008. Field 1010 shows the total number of boxes and weight. A Master Shipping label can be printed by selecting the “M” on the grid 1002. Also available to the user is the option to obtain a printed receipt for the transaction.

The present invention may also include software and computer programs incorporating the process steps and instructions described above that are executed in different computers. FIG. 12 is a block diagram of one embodiment of a typical apparatus incorporating features of the present invention that may be used to practice the present invention. As shown, a computer system 1200 may be linked to another computer system 1202, such that the computers 1200 and 1202 are capable of sending information to each other and receiving information from each other. In one embodiment, computer system 1202 could include a server computer adapted to communicate with a network 1204, such as for example, the Internet. Computer systems 1200 and 1202 can be linked together in any conventional manner including a modem, hard wire connection, fiber optic link or wireless devices. Generally, information can be made available to both computer systems 1200 and 1202 using a communication protocol typically sent over a communication channel or through a dial-up connection on ISDN line. Computers 1200 and 1202 are generally adapted to utilize program storage devices embodying machine readable program source code that is adapted to cause the computers 1200 and 1202 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 1200 and 1202 may also include a microprocessor for executing stored programs. Computer 1200 may include a data storage device 1206 on its program storage device for the storage of information and data. The computer program or software incorporating the processes and method steps incorporating features of the present invention may be stored in one or more computers 1200 and 1202 on an otherwise conventional program storage device. In one embodiment, computers 1200 and 1202 may include a user interface 1207, and a display interface 1208 from which features of the present invention can be accessed. The user interface 1207 and the display interface 1208 can be adapted to allow the input of queries and commands to the system, as well as present the results of the commands and queries.

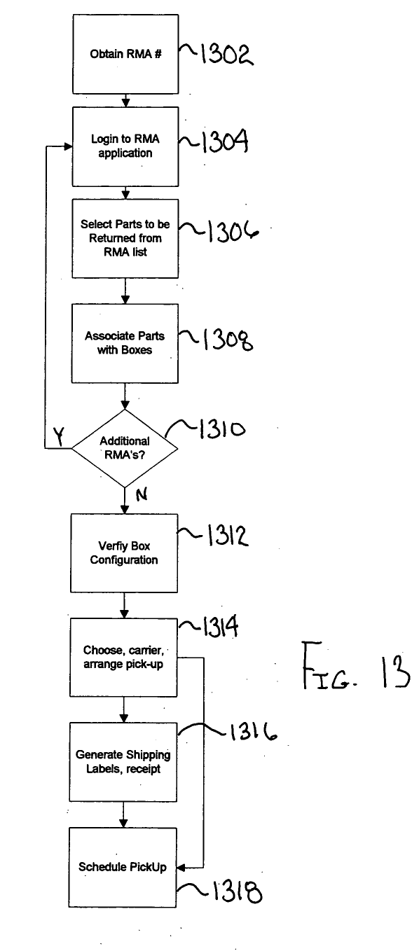

Once the RMA number is obtained, 1302, in FIG. 13, the user can log-in 1304 to the RMA application, for example using a personal computer that can access the internet and the website of the RMA application. Once the RMA number is matched to the RMA number stored at the server of the service center, a list of parts is displayed to the user and the user can select 1306 to return one or more of the parts. It is a feature of the present invention to individually select parts to be returned. The selected parts can then be associated or distributed 1308 into shipping containers or boxes as desired. If there are additional RMA's 1310, those RMA numbers can be entered in and the associated parts list will be displayed. Once all RMA numbers are logged in, the user can verify 1312 each box configuration as displayed on the display screen. The user can then choose 1314 a carrier and a pick-up. Then the user can generate 1316 shipping labels and receipts. The pick-up, not previously automatically scheduled 1318, can then be scheduled.

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims.

1. A method of managing a return of parts comprising:
identifying a set of inventory associated with a return authorization;
identifying which parts of the set of inventory are to be returned;
associating each part being returned with a shipping container in which the part being returned will be shipped, wherein each part number is associated with a shipping container;
determining a total weight for each shipping container;
identifying a shipping date and a shipping carrier;
identifying whether a shipping carrier pick-up needs to be scheduled, and a date and time for the pickup;
printing a shipping label for each shipping container, each label being automatically generated by the system and including a number of the shipping container and a list of parts to be shipped in the shipping container.

2. The method of claim 1 further comprising logging into an online parts return management application using an identifier number associated with the return authorization, wherein the set of inventory associated with the return authorization is displayed.

3. The method of claim 1 further comprising reviewing a configuration of each shipping container in which a part selected to be return is being shipped in, wherein a number of each shipping container is displayed to the user together with information related to the contents contained therein.

4. The method of claim 1 further comprising automatically notifying a shipping carrier to schedule a carrier pick up based on the date and time identified.

5. A method of merchandise return comprising:
accessing a return merchandise application using a unique return merchandise authorization number;
selecting individual parts to be returned from a parts list that is automatically displayed and associated with the return merchandise authorization number;
associating each selected part to be returned with a shipping container in which each selected part is to be returned;
selecting a shipping carrier for shipping each shipping container and scheduling a time and a date for the shipment; and
automatically generating a shipping label for each respective shipping container.

6. The method of claim 5 further comprising accessing the return merchandise application by logging into a website associated with the return merchandise application.

7. The method of claim 5 further comprising, after selecting the parts to be returned, of determining if another return merchandise authorization number is to be associated with this return, and if so, logging in the another return merchandise authorization number and selecting parts to be returned from a new list of parts associated with the another return merchandise authorization number that is displayed.

8. The method of claim 5 further comprising automatically notifying a shipping carrier of the date and time for pick-up of the shipping container.

9. The method of claim 5 further comprising confirming a configuration of each shipping container by activating a portion of a grid being displayed to the user that corresponds to a respective shipping container and reviewing the information displayed pertaining to a content of the respective shipping container.

10. A computer program product comprising:
a computer useable medium having computer readable code means embodied therein for causing a computer to facilitate a return of parts, the computer readable code means in the computer program product comprising:
computer readable program code means for causing a computer to access a return merchandise application using a unique return merchandise authorization number;
computer readable program code means for causing a computer to select individual parts to be returned from a parts list that is automatically displayed and associated with the return merchandise authorization number;
computer readable program code means for causing a computer to select a shipping carrier for shipping each shipping container and scheduling a time and a date for the shipment; and
computer readable program code means for causing a computer to automatically generate a shipping label for each respective shipping container.

11. A graphical user interface adapted for generating a visual display for facilitating a return of merchandise from a customer-to a customer service center comprising:
a display screen;
an image generator for generating on the display screen a menu selection screen for a return merchandise authorization, the menu selection screen comprising:
a user actuatable control to associate a shipping container with a part to be returned as displayed on the display screen;
a user actuatable control to select a shipping container and verify a designated contents of the shipping container as displayed on the display screen;
a user actuatable control to designate a shipping carrier for picking up each shipping container;
a user actuatable control for scheduling a time and date for the pick up and automatically notifying the shipping carrier of the scheduled pick up.

12. The graphical user interface of claim 11 further comprising a user actuatable control for generating a shipping label for each shipping container.
